(19) United States
(12) Patent Application Publication
(10) Pub. No.: US 2005/0120617 A1
(43) Pub. Date: Jun. 9, 2005

(54) Fire ant control method and apparatus

(76) Inventor: Andrew E. Massagee, Ft. Lauderdale, FL (US)

Correspondence Address: John H. Oltman;Oltman, Flynn & Kubler, 915 Middle River Drive # 415, Fort Lauderdale, FL, 33304-3585, US

(21) Appl. No.: 10/729,280

(22) Filed: Dec. 8, 2003

(51) Int. Cl. A01M 17/00; A01M 1/00

(52) U.S. Cl. 43/132.1

(57) ABSTRACT

A method of disrupting the activities of ants in an ant mound having an ant mound upper surface includes the steps of providing a quantity of snow, ice or snowice ice; placing the quantity onto an ant mound upper surface; and permitting the quantity of ice to remain as the ice melts, so that the ice and cold water dripping from the ice lower the temperature of the ant mound upper surface to create a sustained low temperature on the ant mound upper surface and thereby disrupt the activities of ants in the ant mound.

### BACKGROUND OF THE INVENTION

1. Field of the Invention

The present invention relates generally to the field of insect control. More specifically the present invention relates to a method of and apparatus for disrupting the reproductive and food gathering activities of colonies of ants, and especially of fire ants, by placing ice onto an ant mound to create a sustained low temperature on the mound upper surface and thereby to arrest the growth of or eliminate the colony, or by placing ice along a desired barrier line to keep ants from crossing the barrier. The slow rate at which ice melts at most ambient temperatures assures that the lowered temperature produced by the ice can be sustained for a sufficient time to have a significant impact on necessary maintenance activities of an ant colony, and the melting ice is harmless to the environment. The duration of the treatment can be pre-set by selecting appropriate volumes, sizes and shapes of pieces of ice in relation to a given ambient temperature.

In a first version of the method, a quantity of ice, whether in crushed, chopped, cubed or block form, is distributed over the upper surface of an ant mound and permitted to remain until it entirely melts, so that the ice and the cold water dripping from the ice severely lower the temperature of the mound upper surface and slow, disable or disorient ants in their food gathering and mating activities so that the colony is either diminished or eliminated. Additionally or alternatively to covering the mound with ice, a quantity of ice is suspended over the mound and after a time delay elapses is dropped onto the mound to extend the length of time that ice rests on the mound. Snow, snowice or ice mold apparatus is provided for forming an ice block for placement directly onto an ant mound, forming an ice block having an inward depression which fits fully over and around the mound, entirely enclosing the mound while the ice block melts. Another version of the method provides an ant free area where the selected area is covered by a ground cover sheet and then is enclosed by an ice barrier placed around the sheet perimeter for observing and optionally photographing the activities of ants in a nearby ant mound. An ice suspension apparatus is further provided for suspending one or more quantities of ice a distance above an ant mound. A mobile ice making apparatus for producing and dispensing crushed or chopped ice is provided, such as for dispensing ice onto a mound for along a desired barrier line. The mobile ice making apparatus preferably includes a conventional tractor or off-road vehicle fitted with a water tank and ice forming and ice crushing or chopping equipment and an ice pump for creating a flow of snow or slush for depositing onto an ant mound or along a barrier line.

2. Description of the Prior Art

There have long been methods and devices intended to combat and eliminate ant colonies. Some have environmentally hazardous chemicals to kill ants. Others have applied low temperature liquids which are gaseous at ambient temperatures, such as liquid nitrogen and liquid carbon dioxide, to ant mounds to freeze the ants. A problem with these chilling and freezing methods has been that the low temperature liquids quickly evaporate and the duration of low temperate application is too brief to have its maximum effect.

One such freezing method is disclosed in Tallon, U.S. Pat. No. 5,027,546, issued on Jul. 2, 1991, discloses a non-toxic method of exterminating insects including ants, including the step of enveloping an insect colony with liquid nitrogen and maintaining the envelopment and resulting low temperature for two to five minutes. Another is Kirley, U.S. Pat. No. 4,413,756, issued on Nov. 8, 1983, teaches an aerosol insect exterminator device with a cap enclosure which releases an aerosol so that it expands suddenly to form an extremely cold gas for freezing any insect trapped in the cap enclosure. Schmittmann, U.S. Pat. No. 5,394,643, issued Mar. 7, 1995 reveals a fumigant fluid treatment method in which cold carbon dioxide gas is dispensed from a high pressure container into an insect nest to form carbon dioxide snow in the nest. Ammons, U.S. Pat. No. 6,205,702, issued on Mar. 27, 2001 teaches an insect control system involving enveloping an insect colony in carbon dioxide to incapacitate the insects.

Dunn, et al., U.S. Pat. No. Oct. 19, 1976; Martin, et. al., U.S. Pat. No. 4,401,449 issued on Aug. 30, 1983; and Nelson, U.S. Pat. No. 5,005,364, issued on Apr. 9, 1991 disclose a conventional method for making slush products for purposes of example. Hedman, et al., U.S. Pat. No. 6,327,812, issued on Dec. 11, 2001 discloses a method of killing organisms and of removing toxins in enclosures using a stream of hot air and temperature sensing probes.

It is thus an object of the present invention to provide a method and apparatus for disrupting ant colony food gathering and reproductive activities, particularly of a fire ant colony, to diminish or eliminate the colony and to prevent the colony from spreading to new mounds.

It is another object of the present invention to provide such a method which is harmless to the environment and entirely safe for the user.

It is finally an object of the present invention to provide such an apparatus which is simple in its design and inexpensive to manufacture or construct.

### SUMMARY OF THE INVENTION

The present invention accomplishes the above-stated objectives, as well as others, as may be determined by a fair reading and interpretation of the entire specification.

A method is provided of disrupting the activities of ants in an ant mound having an ant mound upper surface, the method including the steps of providing a quantity of snow or snow ice; placing the quantity of ice onto an ant mound upper surface; and permitting the quantity of ice to remain as the ice melts, so that the ice and cold water dripping from the ice lower the temperature of the ant mound upper surface to create a sustained low temperature on the ant mound upper surface and thereby disrupt the activities of ants in the ant mound.

The quantity of ice preferably includes at least one of: snow, snowice, ice slush, crushed ice, chopped ice and an ice block. The method optionally includes the additional steps of placing a first spacer element formed at least in part of ice on one of: the quantity of ice and the ant mound upper surface; and placing an ice block on top of the first spacer element; so that the quantity of ice receives heat from the ant mound and melts faster than the ice block and so that the first spacer element melts and subsequently permits the ice block to drop onto the ant mound upper surface to extend ice contact time on the ant mound. The method optionally includes the additional step of embedding a quantity of insulated capsules in the ice block for release when the ice block melts on the ant mound. The method optionally includes the yet additional steps of placing a second spacer element formed at least in part of ice on top of the ice block; and placing an additional ice block on top of the second spacer element; so that the additional ice block drops onto the ant mound after the second spacer element melts, to further extend ice contact time on the ant mound.

The method optionally includes the additional steps of suspending a quantity of ice over an ant mound with a time release device so that the quantity of ice drops onto the ant mound after a certain length of time. The method preferably includes the additional step of selecting the duration of ice melting on the ant mound, by selecting a volume, size and shape of ice pieces and spacer elements in relation to ambient temperature. Wherein the ant mound is located in soil contained within a flower pot having a flower pot base and a flower pot base, and the quantity of ice preferably is placed onto the soil within the flower pot and also is placed around of the flower pot base periphery.

An ice block mold apparatus is provided for forming an ice block for placement onto an ant mound having a certain general ant mound size and shape, the ice block apparatus including a mold side wall contoured to define an internal mold cavity with an inward bulge structure; and mold opening for releasing a formed ice block from the mold; so that filling the ice block mold with water and then freezing the water produces an ice block having an inward depression formed by the inward bulge structure which fits over and around the ant mound, enclosing the ant mound while the ice block melts. The inward bulge structure preferably has substantially the size and shape of the ant mound.

A method of providing an ant free area is provided, including the steps of placing a ground cover sheet onto a selected area of ground; depositing a line of ice along perimeter of the ground cover sheet to define an ant barrier covering the desired ant free area. The ice preferably is one of: snow, snowice, ice slush, crushed ice and chopped ice. The ground cover sheet is a flexible sheet of a suitable size for supporting a human observer.

An ice suspension apparatus is provided for suspending a quantity of ice over an ant mound, the apparatus including an ice suspension structure including a tubular retaining wall having an open suspension structure upper end and having an open suspension structure lower end for fitting around an ant mound; and an ice suspension structure for retaining the quantity of ice a distance above the ant mound. The quantity of ice preferably is an ice block and the ice suspension structure optionally includes a progressive taper in the retaining wall inwardly in a downward direction so that an ice block of suitable size can be fitted through the open suspension structure upper end and lowered until the ice block wedges within the tapering retaining wall a distance above the ant mound.

Once again, the quantity of ice preferably includes snow, snowice or a first ice block and the open suspension structure upper end includes a retaining wall upper rim and the first ice block suspension structure includes an ice block support bracket engaging the retaining wall upper rim, the bracket projecting radially inwardly from the retaining wall upper rim; so that a first ice block may be fitted onto the block support bracket and thereby suspended above the ant mound until the first ice block melts enough to be released from suspension and drops onto the ant mound. The first ice block preferably has a first ice block lower surface with a first ice block groove and the first ice block support bracket preferably has an upward hook segment for fitting into the first ice block groove for more securely engaging the first ice block.

The apparatus optionally additionally includes a spacer element formed of ice and a second ice block positioned above the first ice block engaged by the ice suspension structure, and spaced above the first ice block with the spacer element resting on top of the first ice block, the second ice block resting on the spacer element. The apparatus may additionally include a spacer element formed of ice and a second ice block positioned above the first ice block engaged by the ice suspension structure, and spaced above the first ice block with the spacer element resting on top of the first ice block, the second ice block resting on the spacer element. The spacer elements preferably include upright ice cylinders, that can be made from snow or snow ice.

The quantity of ice preferably includes a first ice block for placement on an ant mound; a spacer element formed of ice resting on the first ice block; and a second ice block resting on top of the spacer element. The apparatus optionally includes an insulated time release capsule contained within one of the ice blocks.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a top view of the mobile ice making apparatus.

FIG. 2 is a side view of the apparatus of FIG. 1.

FIG. 3 is a rear view of the apparatus of FIG. 1.

FIG. 4 is a front view of the apparatus of FIG. 1.

FIG. 5 is a top view of a ground cover sheet surrounded by an ant barrier in the form of a line of slushed, crushed or chopped ice adjacent to an ant mound.

FIG. 6 is a perspective view of the ground cover sheet and ant mound shown in FIG. 5.

FIG. 7 is a cross-sectional side view of an ant mound covered by a layer of slushed, crushed or chopped ice.

FIG. 8 is a perspective view of a first ice block with ice cylinder spacing elements on top of the first ice block at each ice block corner and a second ice block positioned to be lowered onto the spacing elements.

FIG. 9 is a perspective view of an ice suspension apparatus including a retaining wall with its open suspension structure lower end fitted around an ant mound, showing a portion of the retaining wall cut away to reveal a first ice block wedged in the downwardly tapering retaining wall and a second ice block spaced above the first ice block on ice cylinder spacer elements.

FIGS. 10 and 11 are perspective views of plants in flower pots and slushed, snow, snowice, crushed or chopped ice placed on the soil around each plant within the flower pot and also placed on the ground around the base of each flower pot.

FIG. 12 is top view of the ice suspension apparatus retaining wall of FIG. 9, in which the ice suspension means includes a circumferential series of ice block support brackets engaging the retaining wall upper rim at the open suspension structure upper end, the brackets projecting radially inwardly from the retaining wall upper rim where an ice block is fitted onto the block support brackets, the brackets having inward support segments and upward hook segments fitting into a groove in the ice block lower surface, or other time delay devices.

FIG. 13 is a cross-sectional side view of the ice suspension apparatus of FIG. 12.

FIG. 14 is a top view prior to inversion of an ice mold apparatus for forming an ice block for placement directly onto an ant mound, showing the mold lid and handle.

FIG. 15 is a cross-sectional side view of the ice mold apparatus of FIG. 14, showing the mold chamber and a mold lid with an inward bulge structure similar in size and shape to the target mound and a mold lid handle.

FIG. 16 is a view as in FIG. 15 except that the mold lid is removed and the mold chamber inverted to release the formed ice block onto an ant mound.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### The Method Generally

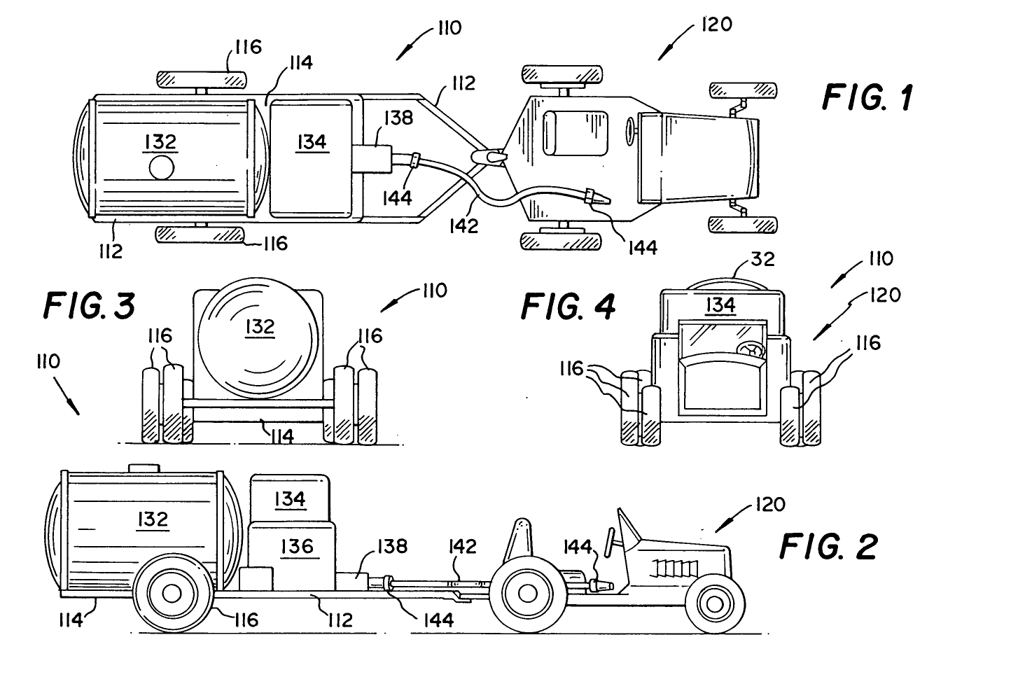

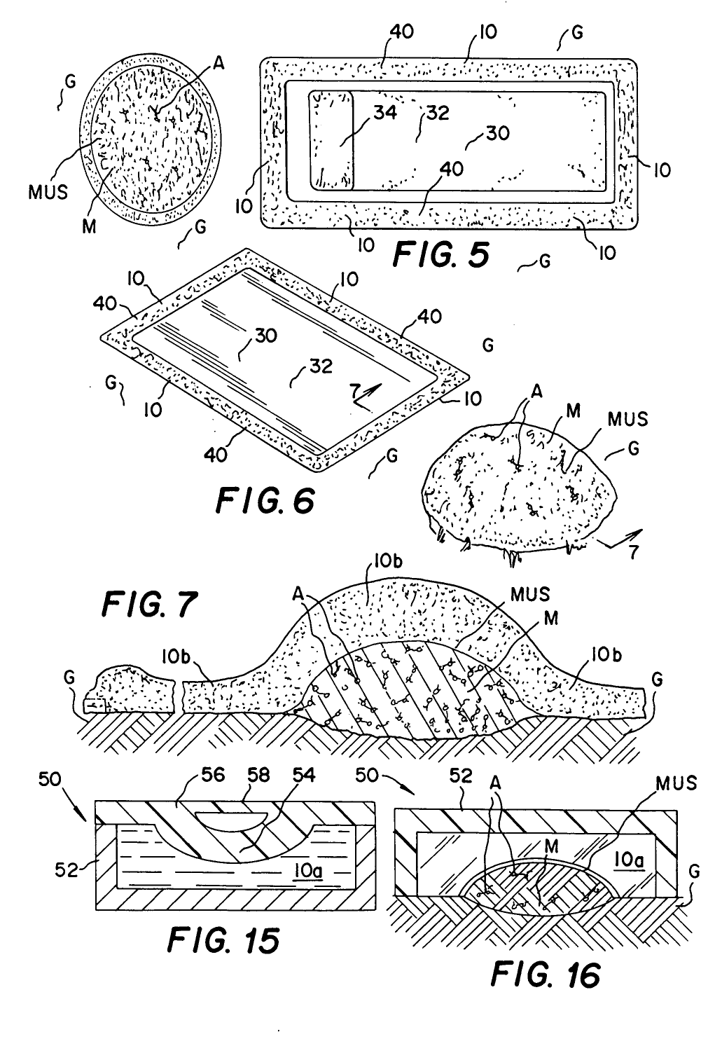

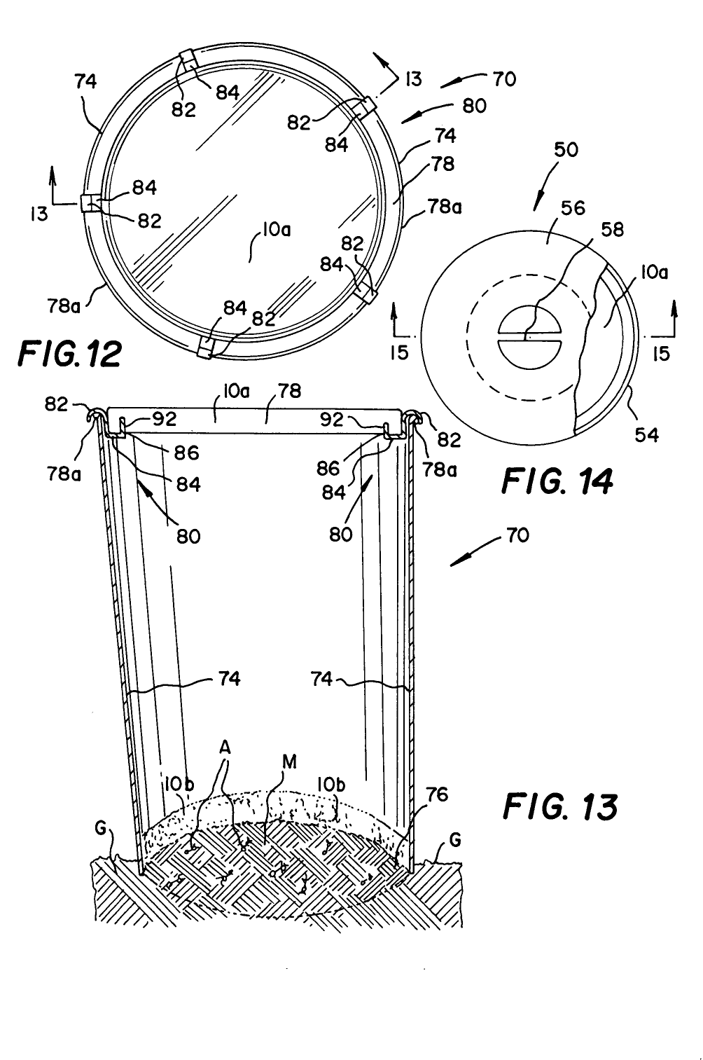

Referred generally to FIGS. 1-16 a method and apparatus are disclosed for disrupting the reproductive and food gathering activities of ants, and especially of fire ants, by placing ice on the upper surface of an ant mound M and the thereby creating a sustained low temperature to arrest the growth of or eliminate the colony, or along a desired barrier line to keep ants from crossing the barrier. The duration of the treatment can be pre-set by selecting appropriate volumes, sizes and shapes of snow, snowice, or ice in relation to a given ambient temperature.

The low temperature produced by the present method has several effects on a fire ant colony, and on colonies of other ant species as well. The ice keeps aggressive ants underground, and the prolonged cold interrupts the activity of the nest or mound M. The ability of the ants to forage for food above ground is stopped and the temperature for incubation of ant eggs is altered. Finally a flight ritual during which the ants A mate in which a new ant queen drops to the ground to lay eggs and start a new mound M is prevented, so that the ant colony cannot form new and separate colonies.

### First Version of Method

In a first version of the method, a quantity of ice 10, whether snow, snowice, crushed, chopped or cubed, ice slush or in block form, is distributed or placed over the upper surface of an ant mound M and permitted to remain until it entirely melts, so that the ice and the cold water dripping from the ice severely lower the temperature of the mound upper surface MUS and slow, disable or disorient ants in their food gathering and mating activities so that the colony is either diminished or eliminated. See FIG. 7. If the mound M is located within a flower pot 20, the ice 10 is spread over the soil within the pot wall 22 and preferably also is placed on the ground G to encircle the base of the pot 20 to prevent passage of ants A from carrying food in and out of the pot drain holes (not shown). See FIGS. 10 and 11.

Additionally or alternatively to covering the mound M with ice 10, an ice block 10a is suspended over the mound M for a certain time and then dropped onto the mound M after a time delay, to extend the time in which ice is resting on the ant mound M. A first spacer element formed at least in part of ice is placed on one of: the quantity of ice 10 on the mound M and the ant mound upper surface; and an ice block is placed on top of the first spacer element; so that the quantity of ice initially placed on the ant mound M receives heat from the ground through the ant mound M and melts faster than the suspended ice block 10a and so that the first spacer element 102 melts and subsequently permits the ice block 10a to drop onto the ant mound upper surface MUS to extend ice 10 contact time on the ant mound M. The method optionally further includes the steps of placing a second spacer element 102 formed at least in part of ice on top of the ice block 102; and placing an additional ice block 10a1 on top of the second spacer element 102; so that the additional ice block 10a1 drops onto the ant mound M after the second spacer element 102 melts, to further extend ice 10 contact time on the ant mound M. An ant control substance such as a poison containing capsule or pellet 150 optionally is contained within one or both ice blocks 10a and 10a1 so that after the block melts on ant mound M, pellet 150 dissolves or ruptures and deposits the substance on the mound M.

### Second Version of Method

Another version of the method provide, an ant free area A enclosed by an ice barrier 40 for observing and optionally photographing the activities of ants A in an adjacent or nearby ant mound M. A ground cover sheet 30 such as a rubber mat with a built in pillow 34, of a suitable size for retaining a human observer and any needed equipment, such as a camera and cam-corder, is placed on the ground G in nearby proximity to an ant mound M. Then an ice barrier 40 line of slush, snow, snowice, crushed or chopped ice 10b is deposited under and around the perimeter of the sheet 30 until a desired area 32 of the sheet upper surface 30a is entirely enclosed by a line of snow, ice, snowice, crushed or chopped ice 10b, the line of snow, snowice, slush, ice 10b defining an ant barrier 40. There can be a wind indicator to aid in keeping ants from blowing on a person standing or sitting in the ice.

### First Preferred Embodiment

Referring to FIGS. 14, 15 and 16, an ice mold apparatus 50 is disclosed for forming an ice block 10a for placement directly onto an ant mound M, so that the ice block 10a has a preferred shape best suited for use with the present method. The ice mold apparatus 50 has a mold side wall defining a mold chamber 52 and a mold lid 56 with an inward bulge structure 54 similar in size and shape to the target mound M, so that filling the mold apparatus 50 with water 12 and then freezing the water 12 produces an ice block 10a having an inward depression 14 which fits fully over, around and in close proximity to the mound upper surface MUS, entirely enclosing the mound M while the ice block 10a melts. The mold lid 56 has a handle 58. The mold chamber 52 with lid 56 removed has an open mold upper end to permit ice block 10a release by inverting mold apparatus 50 after ice block 10a forming.

### Second Preferred Embodiment

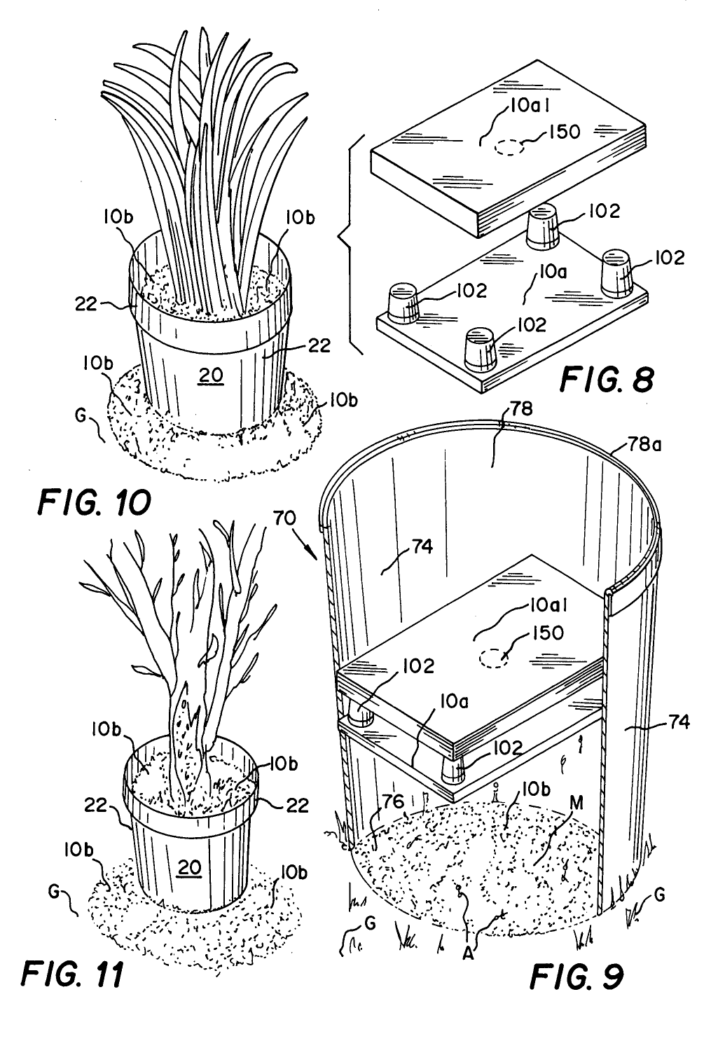

Referring to FIGS. 8, 9, 12 and 13, an ice suspension apparatus 70 is provided for suspending ice, preferably in the form of one or more ice blocks 10a over an ant mound M, the apparatus 70 taking the form of an ice suspension structure 80 including a tubular ant retaining wall 74 having an open suspension structure lower end 76 for fitting against the ground G around an ant mound M and has ice block suspension means 80 for retaining the ice block 10a a distance above the mound M, and having an open suspension structure upper end 78. The ant retaining wall 74 preferably includes heat transfer insulation to sustain the suspended ice block 10a against melting for a longer time.

The ice block suspension means 80 preferably takes the form of a progressive taper in the ant retaining wall 74 inwardly in a downward direction so that an ice block 10a of suitable size can be fitted through open suspension structure upper end 78 and lowered until the ice block 10a wedges within the tapering ant retaining wall 74 a distance above the ant mound M. For this embodiment, a container with its bottom wall removed may function as the ant retaining wall 74.

Alternatively the suspension means 80 may take the form of a circumferential series of ice block support brackets 82 which engage the retaining wall upper rim 78a at the open suspension structure upper end 78, the brackets 82 projecting radially inwardly from the retaining wall upper rim 78a where an ice block 10a is fitted onto the block support brackets 82. The brackets 82 optionally have inward support segments 84 and upward hook segments 86 for fitting into a groove 92 provided in the ice block lower surface 94. Still alternatively the retaining wall upper rim 78a may itself function as the suspension means 80, where the ice block 10a is simply laid across and rests on the retaining wall upper rim 78a. Regardless of the structure of the suspension means 80, a second ice block 10a is optionally positioned above the first ice block 10a engaged by the suspension means 80, with spacer elements 102 resting on top of the first ice block 10a, and the second ice block 10a1 resting on top of the spacer elements 102. The spacer elements 102 preferably are upright ice cylinders. Slush, crushed or chopped ice 10b alternatively may be suspended above a mound M.

### Mobile Ice Making Apparatus

A mobile ice making apparatus 110 for producing and dispensing slush, crushed or chopped ice 10b is provided, such as for delivering ice onto an ant mound M or along a barrier 40 line. See FIGS. 1-4. The ice making apparatus 110 preferably includes a conventional tractor or off-road vehicle 112 pivotally secured to a hitch on a delivery vehicle 120, the vehicle 112 having a trailer floor panel 114 and trailer wheels with tires 116, onto which is mounted a water tank 132 in fluid communication with a conventional freezing and slushing, crushing or chopping unit 134, which drops the snow, snowice, slush, crushed or chopped ice 10b it produces into an ice storage chamber 136 beneath the ice slushing, crushing or chopping unit 134. An ice pump 138 is secured to and in fluid communication with the ice storage chamber 136 and a flexible hose 142 extends from the ice pump 138 for delivery of the ice 10b from the storage chamber 136 onto an ant mound M or along an ice barrier 40 line. One or more solenoid valves 144 preferably are provided at the forward and/or rearward end of the flexible hose 142 to activate and deactivate the flow of ice 10b as needed during a given ice application job.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

1. A method of disrupting the activities of ants in an ant mound having an ant mound upper surface, the method comprising the steps of:
providing a quantity of one of: ice, snow and snowice;
placing the quantity of ice onto an ant mound upper surface;
and permitting the quantity of ice to remain as the ice melts, such that the ice and cold water dripping from the ice lower the temperature of the ant mound upper surface to create a sustained low temperature on the ant mound upper surface and thereby disrupt the activities of ants in the ant mound.

2. The method of claim 1, wherein the quantity of ice comprises at least one of: snow, snowice, ice slush, crushed ice, chopped ice and an ice block.

3. The method of claim 1, comprising the additional steps of:
placing a first spacer element formed at least in part of ice on one of: the quantity of ice and the ant mound upper surface;
and placing an ice block on top of the first spacer element;
such that the quantity of ice receives heat from the ant mound and melts faster than the ice block and such that the first spacer element melts and subsequently permits the ice block to drop onto the ant mound upper surface to extend ice contact time on the ant mound.

4. The method of claim 3, comprising the additional steps of:
placing a second spacer element formed at least in part of ice on top of the ice block;
and placing an additional ice block on top of the second spacer element;
such that the additional ice block drops onto the ant mound after the second spacer element melts, to further extend ice contact time on the ant mound.

5. The method of claim 1, additionally comprising the step of selecting the duration of ice melting on the ant mound, by selecting a volume, size and shape of ice pieces and spacer elements in relation to ambient temperature.

6. The method of claim 1, wherein the ant mound is located in soil contained within a flower pot having a flower pot base and a flower pot base, and wherein the quantity of ice is placed onto the soil within the flower pot and also is placed around of the flower pot base periphery.

7. The method of claim 1, comprising the additional steps of:
suspending a quantity of ice over an ant mound with time release means such that the quantity of ice drops onto the ant mound after a certain length of time.

8. An ice block mold apparatus for forming an ice block for placement onto an ant mound having a certain general ant mound size and shape, comprising:
a mold side wall contoured to define an internal mold cavity with an inward bulge structure;
and mold opening for releasing a formed ice block from the mold;
such that filling said ice block mold with water and then freezing the water produces an ice block having an inward depression formed by said inward bulge structure which fits over and around the ant mound, enclosing the ant mound while the ice block melts.

9. The apparatus of claim 8, wherein said inward bulge structure has substantially the size and shape of the ant mound.

10. A method of providing an ant free area, comprising the steps of:
placing a ground cover sheet onto a selected area of ground;
depositing a line of ice along perimeter of the ground cover sheet in a closed loop to define an ant barrier enclosing the desired ant free area.

11. The method of claim 10, wherein the ice is one of: snow, snowice, ice slush, crushed ice and chopped ice.

12. The method of claim 10, wherein the ground cover sheet is a flexible sheet of a suitable size for supporting a human observer.

13. An ice suspension apparatus for suspending a quantity of ice over an ant mound, said apparatus comprising:
an ice suspension structure including a tubular retaining wall having an open suspension structure upper end and having an open suspension structure lower end for fitting around an ant mound;
and ice suspension means for retaining the quantity of ice a distance above the ant mound.

14. The apparatus of claim 13, wherein said quantity of ice is an ice block and wherein said ice suspension means comprises a progressive taper in said retaining wall inwardly in a downward direction such that an ice block of suitable size can be fitted through said open suspension structure upper end and lowered until the ice block wedges within the tapering retaining wall a distance above the ant mound.

15. The apparatus of claim 13, wherein said quantity of ice comprises a first ice block and wherein said open suspension structure upper end comprises a retaining wall upper rim and wherein said first ice block suspension means comprises an ice block support bracket engaging said retaining wall upper rim, said bracket projecting radially inwardly from said retaining wall upper rim;
such that a first ice block may be fitted onto said block support bracket and thereby suspended above the ant mound until the first ice block melts enough to be released from suspension and drops onto the ant mound.

16. The apparatus of claim 13, wherein said first ice block has a first ice block lower surface with a first ice block groove and wherein said first ice block support bracket has an upward hook segment for fitting into the first ice block groove for more securely engaging the first ice block.

17. The apparatus of claim 14, additionally comprising a spacer element formed of ice and a second ice block positioned above said first ice block engaged by said ice suspension means, and spaced above said first ice block with said spacer element resting on top of said first ice block, said second ice block resting on said spacer element.

18. The apparatus of claim 15, additionally comprising a spacer element formed of ice and a second ice block positioned above said first ice block engaged by said ice suspension means, and spaced above said first ice block with said spacer element resting on top of said first ice block, said second ice block resting on said spacer element.

19. The apparatus of claim 17, wherein said spacer elements comprise upright ice cylinders.

20. The apparatus of claim 18, wherein said spacer elements comprise upright ice cylinders.

21. The apparatus of claim 14, wherein said quantity of ice comprises:
a first ice block for placement on an ant mound;
a spacer element formed of ice resting on top of said first ice block;
and a second ice block resting on top of said spacer element.

22. The apparatus of claim 21, additionally comprising an insulated, time release capsule contained within one of said ice blocks.

23. The method of claim 2, comprising the additional step of:
embedding a quantity of controlled substance in said ice block for release when said ice block melts on the ant mount.
